(19) United States
(12) Patent Application Publication
(10) Pub. No.: US 2026/0366543 A1
(43) Pub. Date: Nov. 19, 2026

(54) HYDRAULIC DRIVE CIRCUIT

(71) Applicant: KOMATSU LTD., Tokyo (JP)

(72) Inventors: Yuusuke Miyamoto, Tokyo (JP); Yuichi Hishinuma, Tokyo (JP)

(73) Assignee: KOMATSU LTD., Tokyo (JP)

(21) Appl. No.: 19/515,810

(22) PCT Filed: Sep. 26, 2023
(86) PCT No.: PCT/JP2023/034885

§ 371 Date: Mar. 3, 2026

(51) Int. Cl. F15B 13/04; F15B 13/02

(52) U.S. Cl. CPC F15B 13/0402; F15B 13/024

(57) ABSTRACT

A hydraulic drive circuit for controlling oil supply from a pump to an actuator includes a direction switching valve provided with a pump port, first and second actuator ports, and first, second, and third bridge ports, wherein a bridge oil passage links the first and second bridge ports and a communication oil passage connects the bridge oil passage to the third bridge port. Further, the spool is configured to connect the pump port to the third bridge port while selectively routing oil to either actuator port through the shared bridge passage, with a single relief valve provided in either the bridge or communication oil passage to prevent excessive pressure during supply to either actuator port.

### TECHNICAL FIELD

The present invention relates to a hydraulic drive circuit that executes supply control of oil from a hydraulic pump to a hydraulic actuator by operating a spool.

### BACKGROUND ART

For example, in a hydraulic drive circuit that executes supply control of oil to a hydraulic cylinder, a first actuator port and a second actuator port are provided in a spool hole of a direction switching valve. The first actuator port is connected to a bottom chamber of the hydraulic cylinder, and the second actuator port is connected to a rod chamber. The spool is operated from this state. With this, the first actuator port and the second actuator port are selectively connected to a hydraulic pump, and the hydraulic cylinder reciprocates between an extended state and a retracted state. In the hydraulic drive circuit of this type, a relief valve is interposed in an oil passage that supplies oil from the spool to the hydraulic cylinder. With this, supply of oil at a pressure equal to or higher than a set pressure to the hydraulic cylinder is prevented (see, for example, Patent Literature 1).

### CITATION LIST

### Patent Literature

Patent Literature 1: JP 2003-202003 A

### SUMMARY OF INVENTION

### Technical Problem

The relief valve described above needs to function both in a case of supplying oil to the bottom chamber and in a case of supplying oil to the rod chamber. In other words, in the above-described hydraulic drive circuit, by providing a relief valve in each oil passage that supplies oil from the spool to the hydraulic cylinder, it is possible to prevent a situation where an excessive hydraulic pressure is applied to each of the bottom chamber and the rod chamber. However, in the related art, a plurality of relief valves are required, and hence it is inevitable that manufacturing cost increases. Such a problem is not limited to a hydraulic actuator being a hydraulic cylinder, but can similarly occur in other hydraulic actuators such as a hydraulic motor.

In view of the circumstances described above, the present invention has an object to provide a hydraulic drive circuit that can reduce manufacturing cost.

### Solution to Problem

In order to solve the above-mentioned object, a hydraulic drive circuit according to the present invention is a hydraulic drive circuit that executes supply control of oil from a hydraulic pump with respect to a hydraulic actuator by operating a spool of a direction switching valve interposed between the hydraulic pump and the hydraulic actuator. The direction switching valve is provided with a pump oil supply port that is connected to the hydraulic pump, a first actuator port and a second actuator port that are connected to the hydraulic actuator, a first bridge port, a second bridge port, and a third bridge port, a bridge oil passage that links the first bridge port and the second bridge port to each other, and a communication oil passage that connects the bridge oil passage and the third bridge port to each other. When the spool is arranged at a first position, the pump oil supply port and the third bridge port are connected to each other, the first bridge port is blocked, and the second bridge port and the second actuator port are connected to each other. When the spool is arranged at a second position, the pump oil supply port and the third bridge port are connected to each other, the second bridge port is blocked, and the first bridge port and the first actuator port are connected to each other. A relief valve is provided to any one of the bridge oil passage or the communication oil passage.

### Advantageous Effects of Invention

According to the present invention, in either a case of supplying oil from the first actuator port or a case of supplying oil from the second actuator port, the oil passes through a communication oil passage and a bridge oil passage. Therefore, in a case in which only one relief valve is provided in the communication oil passage or the bridge oil passage, even when oil is supplied from any one of the two actuator ports, pressure relief can be achieved when the hydraulic pressure is equal to or higher than a set pressure. With this, application of an excessive pressure to a hydraulic actuator can be prevented while suppressing manufacturing cost.

### BRIEF DESCRIPTION OF DRAWINGS

FIG. 1 is a circuit diagram of a state in which a spool is arranged at a neutral position in a hydraulic drive circuit being a first embodiment of the present invention.

FIG. 2 is a cross-sectional view illustrating a structure of the hydraulic drive circuit illustrated in FIG. 1.

FIG. 3 is a circuit diagram of a state in which the spool is arranged at a first position in the hydraulic drive circuit illustrated in FIG. 1.

FIG. 4 is a cross-sectional view illustrating a structure of the hydraulic drive circuit illustrated in FIG. 3.

FIG. 5 is a circuit diagram of a state in which the spool is arranged at a second position in the hydraulic drive circuit illustrated in FIG. 1.

FIG. 6 is a cross-sectional view illustrating a structure of the hydraulic drive circuit illustrated in FIG. 5.

FIG. 7 is a circuit diagram of a state in which a spool is arranged at a neutral position in a hydraulic drive circuit being a second embodiment of the present invention.

FIG. 8 is a circuit diagram of a state in which the spool is arranged at a first position in the hydraulic drive circuit illustrated in FIG. 7.

FIG. 9 is a circuit diagram of a state in which the spool is arranged at a second position in the hydraulic drive circuit illustrated in FIG. 7.

### DESCRIPTION OF EMBODIMENTS

Hereinafter, with reference to the accompanying drawings, preferred embodiments of a hydraulic drive circuit according to the present invention is described in detail.

### First Embodiment

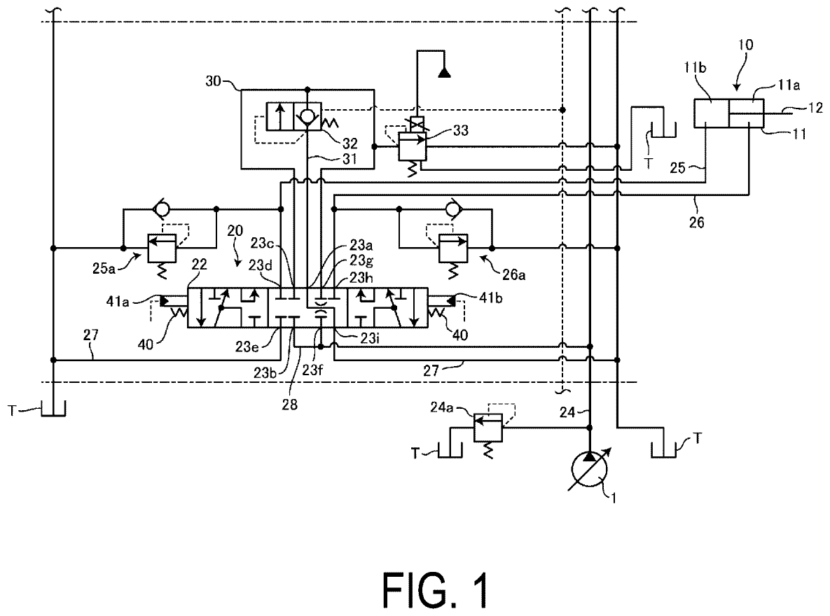

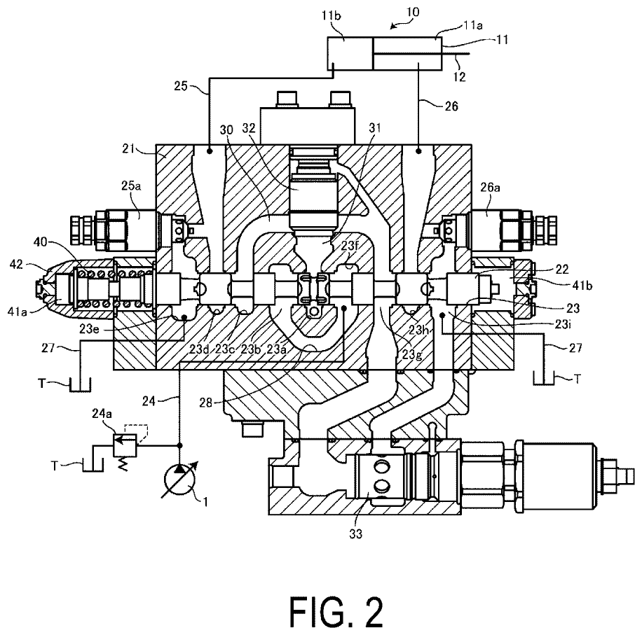

FIG. 1 and FIG. 2 illustrate a hydraulic drive circuit being a first embodiment of the present invention. The hydraulic drive circuit exemplified herein drives a hydraulic cylinder (hydraulic actuator) 10 using oil supplied from a hydraulic pump 1. The hydraulic pump 1 is of a variable displacement type in which a displacement volume is varied by changing an inclination angle of a swash plate or a swash shaft. The hydraulic cylinder 10 is of a double-acting type in which an operation rod 12 reciprocates with respect to a cylinder main body 11 by selectively supplying oil to a rod chamber 11a and a bottom chamber 11b. The hydraulic cylinder 10 of this type is applicable as at least one of a boom hydraulic cylinder, an arm hydraulic cylinder, and a bucket hydraulic cylinder that are provided to a work machine, for example.

A hydraulic valve device is provided between the hydraulic pump 1 and the hydraulic cylinder 10. The hydraulic valve device includes a direction switching valve 20 that selectively supplies oil from the hydraulic pump 1 with respect to the rod chamber 11a and the bottom chamber 11b of the hydraulic cylinder 10, and a valve main body 21 is provided with a spool 22. The spool 22 has a cylindrical shape having a plurality of land portions divided by annular grooves, and is arranged in a spool hole 23 of the valve main body 21 so as to be movable along an axial direction.

The spool hole 23 of the valve main body 21 that accommodates the spool 22 is provided with a center bridge port (third bridge port) 23a at a substantially center part in the axial direction in FIG. 2. In the spool hole 23, a first pump oil supply port 23b, a first bridge port 23c, a first actuator port 23d, and a first tank port 23e are provided sequentially in a part located on a left side of the center bridge port 23a in FIG. 2. In the spool hole 23, a second pump oil supply port 23f, a second bridge port 23g, a second actuator port 23h, and a second tank port 23i are provided sequentially in a part located on a right side of the center bridge port 23a in FIG. 2.

When the spool 22 moves in the axial direction, a connection state between the first pump oil supply port 23b and the second pump oil supply port 23f, and the center bridge port 23a and a connection state between the first bridge port 23c and the second bridge port 23g, and the first actuator port 23d and the second actuator port 23h are switched respectively.

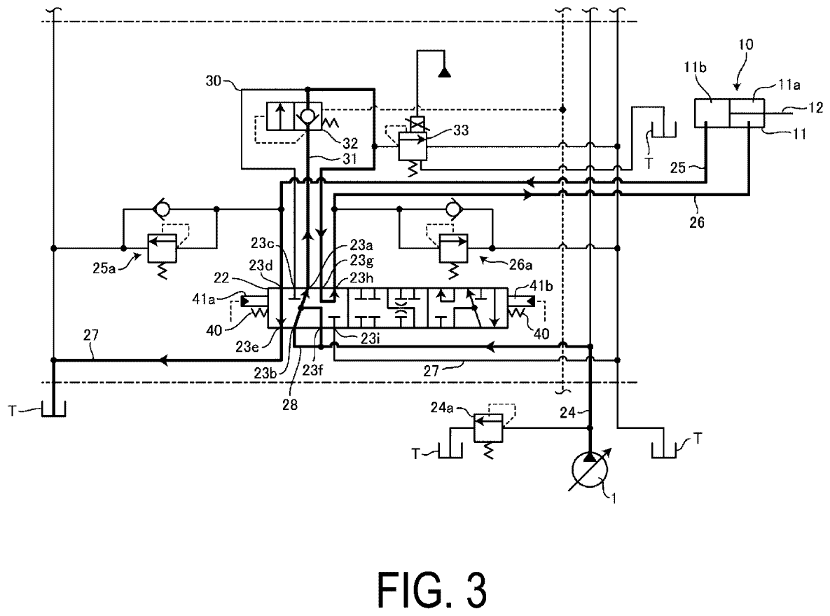

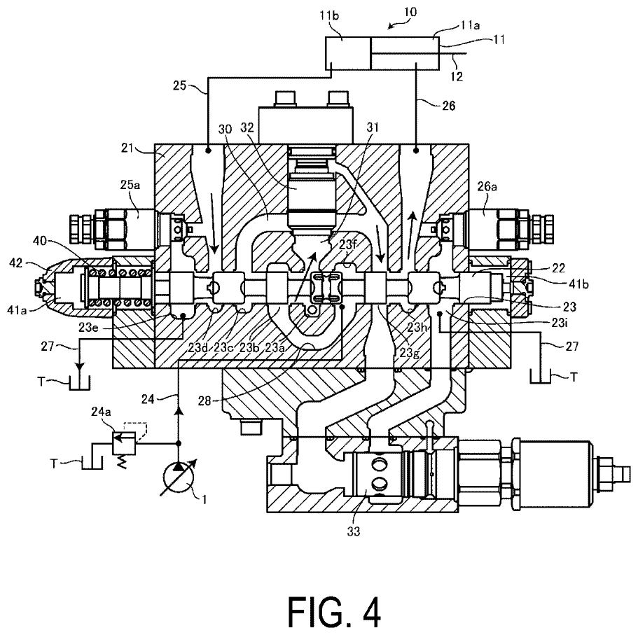

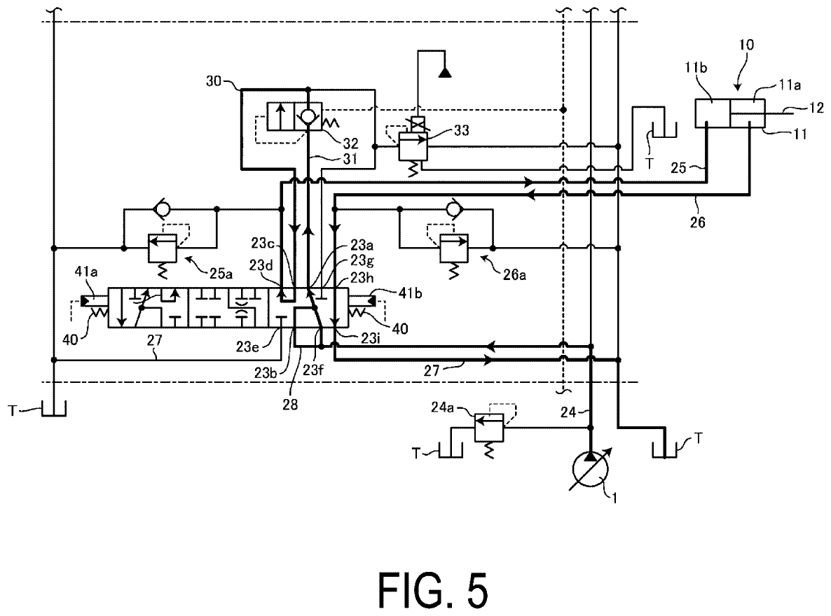

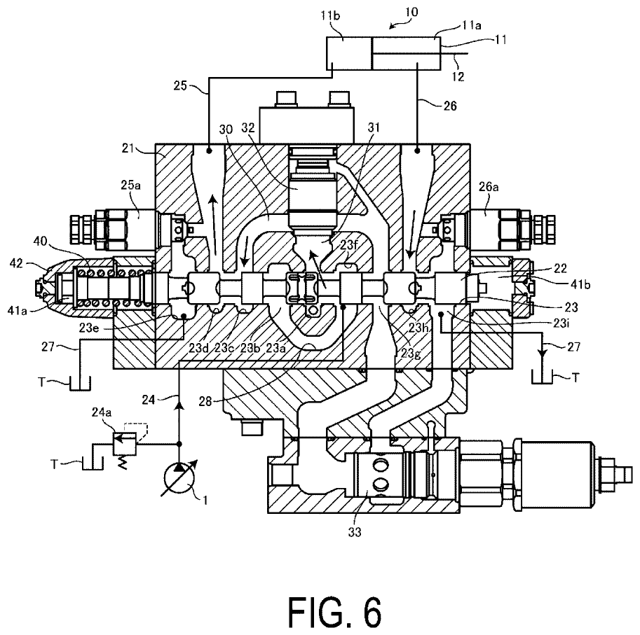

More specifically, when the spool 22 is arranged at a neutral position, the center bridge port 23a is connected to the second tank port 23i. Meanwhile, the first pump oil supply port 23b, the second pump oil supply port 23f, the first bridge port 23c, the second bridge port 23g, the first actuator port 23d, and the second actuator port 23h are all in a state of being blocked. When the spool 22 moves from the neutral position to the right side in FIG. 1, the center bridge port 23a and the first pump oil supply port 23b are connected to each other, and the second bridge port 23g and the second actuator port 23h are connected to each other, while the first actuator port 23d is in a state of being connected to the first tank port 23e, as illustrated in FIG. 3 and FIG. 4. The first bridge port 23c and the second tank port 23i are all maintained in a state of being blocked (a first position of the spool 22). When the spool 22 moves from the neutral position to the left side in FIG. 1, the center bridge port 23a and the second pump oil supply port 23f are connected to each other, and the first bridge port 23c and the first actuator port 23d are connected to each other, while the second actuator port 23h is in a state of being connected to the second tank port 23i, as illustrated in FIG. 5 and FIG. 6. The second bridge port 23g and the first tank port 23e are all maintained in a state of being blocked (a second position of the spool 22).

The second pump oil supply port 23f of the spool hole 23 is connected to the hydraulic pump 1 via a supply oil passage 24. The supply oil passage 24 is provided with a main relief valve 24a. The first actuator port 23d of the spool hole 23 is connected to the bottom chamber 11b of the hydraulic cylinder 10 via a bottom oil passage 25, and the second actuator port 23h is connected to the rod chamber 11a of the hydraulic cylinder 10 via a rod oil passage 26. Suction safety valves 25a and 26a are provided at the center portion of the bottom oil passage 25 and the center portion of the rod oil passage 26, respectively. The suction safety valves 25a and 26a link the oil passages 25 and 26 to a tank T only when the respective pressures of the oil passages 25 and 26 exceed set values. In contrast, when the respective pressures of the oil passages 25 and 26 are negative pressures, the suction safety valves 25a and 26a allow passage of oil from the tank T to the bottom oil passage 25 and the rod oil passage 26. The first tank port 23e and the second tank port 23i of the spool hole 23 are respectively connected to the tank T via a drain oil passage 27.

The first pump oil supply port 23b and the second pump oil supply port 23f are linked to each other by a pump supply oil passage 28 provided to the valve main body 21. The pump supply oil passage 28 extends from the first pump oil supply port 23b to the outer periphery side along the radial direction of the spool 22, then is curved, and extends in a direction approaching the spool 22 along the radial direction of the spool 22. With this, the pump supply oil passage 28 is linked to the second pump oil supply port 23f.

A bridge oil passage 30 provided to the valve main body 21 links the first bridge port 23c and the second bridge port 23g to each other. The bridge oil passage 30 extends from the first bridge port 23c to the outer periphery side along the radial direction of the spool 22, then is curved to the right side in FIG. 2, and extend along the axial direction of the spool 22. Further, the extending end portion extends in a direction approaching the spool 22 along the radial direction of the spool 22.

With this, the bridge oil passage 30 is linked to the second bridge port 23g. In the illustrated example, the pump supply oil passage 28 and the bridge oil passage 30 are provided at positions deviated from each other by 180 degrees in the periphery of the spool 22. A communication oil passage 31 is provided between the bridge oil passage 30 and the center bridge port 23a. The communication oil passage 31 extends from the center bridge port 23a to the outer periphery side along the radial direction of the spool 22. With this, the extending edge portion is linked to the center portion of the bridge oil passage 30.

The communication oil passage 31 is provided with a pressure compensation valve 32, and the bridge oil passage 30 is provided with a relief valve 33. The pressure compensation valve 32 is configured to increase an opening degree when a pressure on the bridge oil passage 30 side is higher than a pressure on the center bridge port 23a side. The relief valve 33 opens when the pressure of the bridge oil passage 30 exceeds a pre-set relief pressure (<a set pressure of main relief valve 24a), and discharges oil to the tank T. In the first embodiment, the relief valve 33 of an electromagnetic type capable of changing a relief pressure in accordance with a given control signal is applied.

The spool 22 is provided with a neutral spring 40 at one end portion and pressure chambers 41a and 41b at both end portions. The neutral spring 40 maintains the spool 22 at the neutral position, and is accommodated inside a spring box 42. The pressure chambers 41a and 41b accommodate the end portions of the spool 22, and are filled with oil inside. Although not clearly illustrated in the drawing, pilot oil passages for applying a pilot pressure that is output from an operation valve are individually connected to the respective pressure chambers 41a and 41b. When a pilot pressure that is output in association with operation of the operation valve is applied to the pressure chambers 41a and 41b through the pilot oil passages, the spool 22 can be moved along the axial direction against the spring force of the neutral spring 40. By removing a pilot pressure applied to the pressure chambers 41a and 41b, the spool 22 returns to the neutral position due to the spring force of the neutral spring 40.

In the hydraulic drive circuit configured as described above, when the spool 22 is arranged at the neutral position, the first pump oil supply port 23b, the second pump oil supply port 23f, the first bridge port 23c, the second bridge port 23g, the first actuator port 23d, and the second actuator port 23h are all in a state of being blocked as described above. Therefore, there is no flow of oil to the rod chamber 11a and the bottom chamber 11b of the hydraulic cylinder 10, and the operation rod 12 maintains a current position with respect to the cylinder main body 11.

When the spool 22 moves from this state to the right side in FIG. 1 and FIG. 2 by operation of the operation valve, oil supplied from the hydraulic pump 1 to the supply oil passage 24 is supplied to the rod chamber 11a of the hydraulic cylinder 10 via the second pump oil supply port 23f, the center bridge port 23a, the communication oil passage 31, the pressure compensation valve 32, the bridge oil passage 30, the second bridge port 23g, the second actuator port 23h, and the rod oil passage 26, as illustrated in FIG. 3 and FIG. 4. At the same time, oil in the bottom chamber 11b is discharged to the tank T via the bottom oil passage 25, the first actuator port 23d, the first tank port 23e, and the drain oil passage 27. Therefore, in the hydraulic cylinder 10, the operation rod 12 is retracted with respect to the cylinder main body 11.

In contrast, when the spool 22 moves to the left side in the drawing by operation of the operation valve, oil supplied from the hydraulic pump 1 to the supply oil passage 24 is supplied to the bottom chamber 11b of the hydraulic cylinder 10 via the second pump oil supply port 23f, the center bridge port 23a, the communication oil passage 31, the pressure compensation valve 32, the bridge oil passage 30, the first bridge port 23c, the first actuator port 23d, and the bottom oil passage 25, as illustrated in FIG. 5 and FIG. 6. At the same time, oil in the rod chamber 11a is discharged to the tank T via the rod oil passage 26, the second actuator port 23h, the second tank port 23i, and the drain oil passage 27. Therefore, in the hydraulic cylinder 10, the operation rod 12 is extended with respect to the cylinder main body 11.

During such operation, according to the hydraulic drive circuit, in either a case of supplying oil to the bottom chamber 11b of the hydraulic cylinder 10 or a case of supplying oil to the rod chamber 11a, oil passes through the communication oil passage 31 and the bridge oil passage 30. Therefore, only the relief valve 33 is provided to the bridge oil passage 30, but even in a case in which oil is supplied to any one of the bottom chamber 11b or the rod chamber 11a, pressure relief can be achieved when an oil pressure is equal to or higher than the set pressure. With this, application of an excessive pressure to the hydraulic cylinder 10 can be prevented while reducing manufacturing cost.

Note that, in the first embodiment described above, the bridge oil passage 30 is provided with the relief valve 33. However, the present invention is not limited thereto. The relief valve 33 may be provided to a part between the pressure compensation valve 32 and the bridge oil passage 30 in the communication oil passage 31.

### Second Embodiment

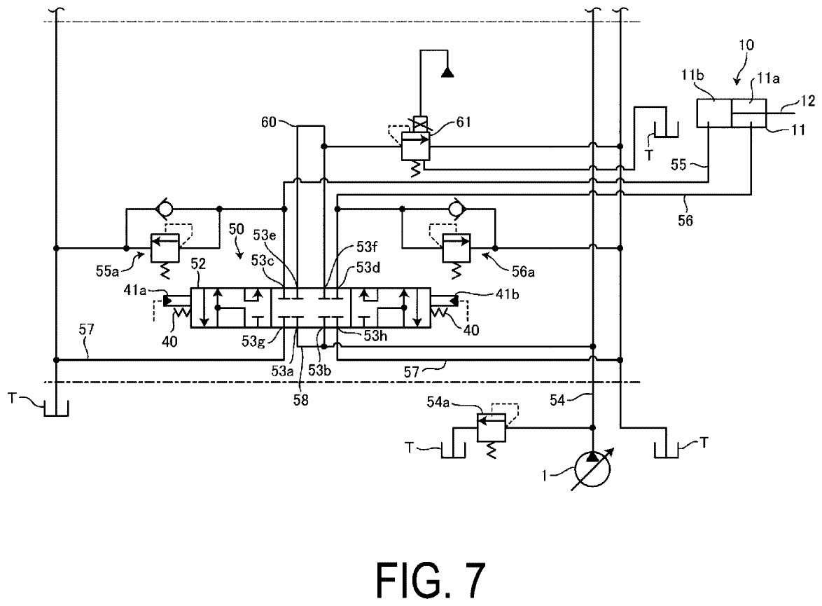

FIG. 7 illustrates a hydraulic drive circuit being a second embodiment of the present invention. Similarly to the first embodiment, the hydraulic drive circuit exemplified herein drives the hydraulic cylinder (hydraulic actuator) 10 by oil supplied from the hydraulic pump 1, and is different only in a configuration of the hydraulic valve device. Hereinafter, configurations that are different from those in the first embodiment are described, and other common configurations are denoted with the same reference symbols.

In the hydraulic valve device of the second embodiment, a spool hole of a valve main body that accommodates a spool 52 of a direction switching valve 50 is provided with a first pump oil supply port 53a and a second pump oil supply port 53b, a first actuator port 53c and a second actuator port 53d, a first bridge port 53e and a second bridge port 53f, and a first tank port 53g and a second tank port 53h. When the spool 52 moves in the axial direction, a connection state between the first pump oil supply port 53a and the second pump oil supply port 53b, and the first bridge port 53e, the second bridge port 53f, the first actuator port 53c and the second actuator port 53d is switched, respectively.

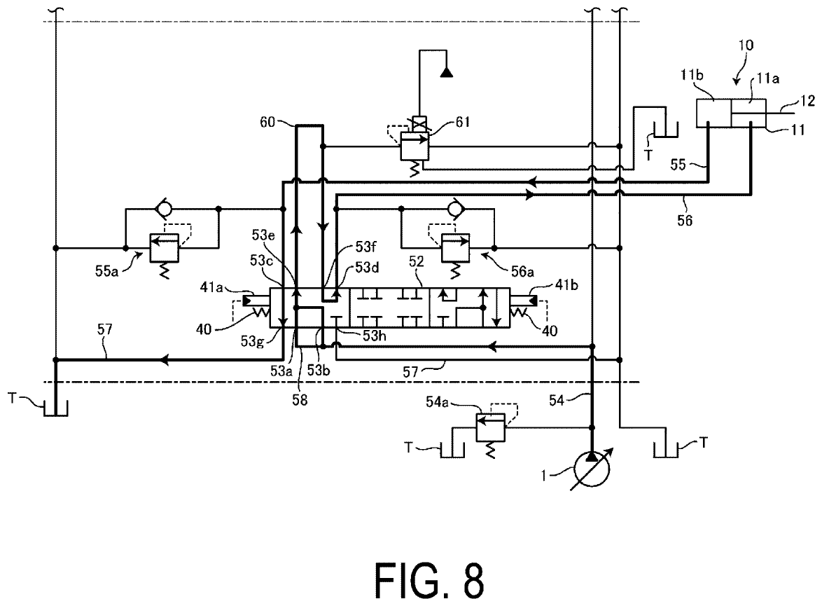

More specifically, when the spool 52 is arranged at the neutral position, the first pump oil supply port 53a, the second pump oil supply port 53b, the first bridge port 53e, the second bridge port 53f, the first actuator port 53c, and the second actuator port 53d are all in a state of being blocked. When the spool 52 moves from the neutral position to the right side in FIG. 7, the first pump oil supply port 53a and the first bridge port 53e are connected to each other, and the second bridge port 53f and the second actuator port 53d are connected to each other, while the first actuator port 53c is in a state of being connected to the first tank port 53g, as illustrated in FIG. 8. When the spool 52 moves from the neutral position to the left side in the drawing, the second pump oil supply port 53b and the second bridge port 53f are connected to each other, and the first bridge port 53e and the first actuator port 53c are connected to each other, while the second actuator port 53d is in a state of being connected to the second tank port 53h.

The second pump oil supply port 53b of the spool hole is connected to the hydraulic pump 1 via a supply oil passage 54. The supply oil passage 54 is provided with a main relief valve 54a. The first actuator port 53c of the spool hole is connected to the bottom chamber 11b of the hydraulic cylinder 10 via a bottom oil passage 55, and the second actuator port 53d is connected to the rod chamber 11a of the hydraulic cylinder 10 via a rod oil passage 56. Suction safety valves 55a and 56a are provided at the center portion of the bottom oil passage 55 and the center portion of the rod oil passage 56, respectively. The first tank port 53g and the second tank port 53h of the spool hole are respectively connected to the tank T via a drain oil passage 57. The first pump oil supply port 53a and the second pump oil supply port 53b are linked to each other by a pump supply oil passage 58 provided to the valve main body.

The first bridge port 53e and the second bridge port 53f are linked to each other by a bridge oil passage 60 provided to the valve main body. The bridge oil passage 60 is provided with a relief valve 61. The relief valve 61 opens when the pressure of the bridge oil passage 60 exceeds a pre-set relief pressure (<a set pressure of the main relief valve 54a), and discharges oil to the tank T. In the second embodiment, the relief valve 61 of an electromagnetic type capable of changing a relief pressure in accordance with a given control signal is also applied.

In the hydraulic drive circuit configured as described above, when the spool 52 is arranged at the neutral position, the first pump oil supply port 53a, the second pump oil supply port 53b, the first bridge port 53e, the second bridge port 53f, the first actuator port 53c, and the second actuator port 53d are all in a state of being blocked as described above. Therefore, there is no flow of oil to the rod chamber 11a and the bottom chamber 11b of the hydraulic cylinder 10, and the operation rod 12 maintains a current position with respect to the cylinder main body 11.

When the spool 52 moves from this state to the right side in FIG. 7 by operation of the operation valve, oil supplied from the hydraulic pump 1 to the supply oil passage 54 is supplied to the rod chamber 11a of the hydraulic cylinder 10 via the first pump oil supply port 53a, the first bridge port 53e, the bridge oil passage 60, the second bridge port 53f, the second actuator port 53d, and the rod oil passage 56, as illustrated in FIG. 8. At the same time, oil in the bottom chamber 11b is discharged to the tank T via the bottom oil passage 55, the first actuator port 53c, the first tank port 53g, and the drain oil passage 57. Therefore, in the hydraulic cylinder 10, the operation rod 12 is retracted with respect to the cylinder main body 11.

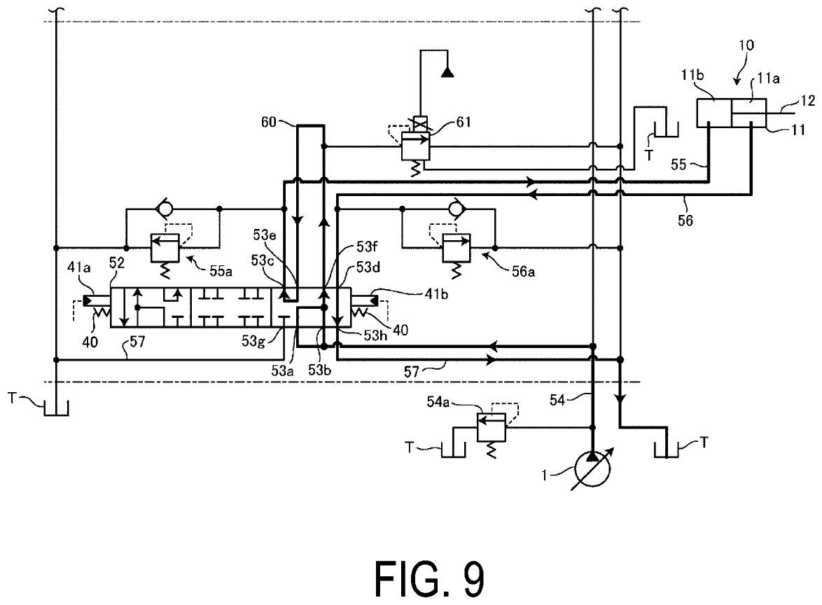

In contrast, when the spool 52 moves to the left side in FIG. 7 by operation of the operation valve, oil supplied from the hydraulic pump 1 to the supply oil passage 54 is supplied to the bottom chamber 11b of the hydraulic cylinder 10 via the second pump oil supply port 53b, the second bridge port 53f, the bridge oil passage 60, the first bridge port 53e, the first actuator port 53c, and the bottom oil passage 55, as illustrated in FIG. 9. At the same time, oil in the rod chamber 11a is discharged to the tank T via the rod oil passage 56, the second actuator port 53d, the second tank port 53h, and the drain oil passage 57. Therefore, in the hydraulic cylinder 10, the operation rod 12 is extended with respect to the cylinder main body 11.

During such operation, according to the hydraulic drive circuit, in either a case of supplying oil to the bottom chamber 11b of the hydraulic cylinder 10 or a case of supplying oil to the rod chamber 11a, oil passes through the bridge oil passage 60. Therefore, only the relief valve 61 is provided to the bridge oil passage 60, but even in a case in which oil is supplied to any one of the bottom chamber 11b or the rod chamber 11a, pressure relief can be achieved when an oil pressure is equal to or higher than the set pressure. With this, application of an excessive pressure to the hydraulic cylinder 10 can be prevented while reducing manufacturing cost.

Note that, in both the embodiments described above, the hydraulic cylinder 10 is exemplified as a hydraulic actuator, and may be applicable to those that execute supply control of oil with respect to other hydraulic actuators such as a hydraulic motor. Further, a relief valve of an electro-magnetic type is exemplified as the relief valves 33 and 61, but the present invention is not limited thereto.

### REFERENCE SIGNS LIST

1 Hydraulic pump
10 Hydraulic cylinder
20, 50 Direction switching valve
22, 52 Spool
23a Center bridge port (third bridge port)
23b, 53a First pump oil supply port
23c, 53e First bridge port
23d, 53c First actuator port
23e, 53g First tank port
23f, 53b Second pump oil supply port
23g, 53f Second bridge port
23h, 53d Second actuator port
23i, 53h Second tank port
28, 58 Pump supply oil passage
30, 60 Bridge oil passage
31 Communication oil passage
32 Pressure compensation valve
33,61 Relief Valve
T Tank

1. A hydraulic drive circuit that executes supply control of oil from a hydraulic pump with respect to a hydraulic actuator by operating a spool of a direction switching valve interposed between the hydraulic pump and the hydraulic actuator, wherein
the direction switching valve is provided with:
a pump oil supply port that is connected to the hydraulic pump;
a first actuator port and a second actuator port that are connected to the hydraulic actuator;
a first bridge port, a second bridge port, and a third bridge port;
a bridge oil passage that links the first bridge port and the second bridge port to each other; and
a communication oil passage that connects the bridge oil passage and the third bridge port to each other,
when the spool is arranged at a first position, the pump oil supply port and the third bridge port are connected to each other, the first bridge port is blocked, and the second bridge port and the second actuator port are connected to each other,
when the spool is arranged at a second position, the pump oil supply port and the third bridge port are connected to each other, the second bridge port is blocked, and the first bridge port and the first actuator port are connected to each other, and
a relief valve is provided to any one of the bridge oil passage or the communication oil passage.

2. The hydraulic drive circuit according to claim 1, wherein
the communication oil passage is provided with a pressure compensation valve that controls a supply flow rate of oil to the hydraulic actuator in accordance with a load pressure of the hydraulic actuator.

3. The hydraulic drive circuit according to claim 1, wherein
the direction switching valve is provided with the third bridge port at a center part in an axial direction,
the pump oil supply port, the first bridge port, the first actuator port, and a tank port connected to a tank are provided sequentially from the third bridge port to one end portion,
the pump oil supply port, the second bridge port, the second actuator port, and a tank port connected to a tank are provided sequentially from the third bridge port to the other end portion,
the pump oil supply port provided on the one end portion side with respect to the third bridge port and the pump oil supply port that is provided on the other end portion side with respect to the third bridge port are connected to each other by a pump communication oil passage.

4. A hydraulic drive circuit that executes supply control of oil from a hydraulic pump with respect to a hydraulic actuator by operating a spool of a direction switching valve interposed between the hydraulic pump and the hydraulic actuator, wherein
the direction switching valve is provided with:
a pump oil supply port that is connected to the hydraulic pump;
a first actuator port and a second actuator port that are connected to the hydraulic actuator;
a first bridge port and a second bridge port; and
a bridge oil passage that links the first bridge port and the second bridge port to each other,
when the spool is arranged at a first position, the pump oil supply port and the first bridge port are connected to each other, and the second bridge port and the second actuator port are connected to each other,
when the spool is arranged at a second position, the pump oil supply port and the second bridge port are connected to each other, and the first bridge port and the first actuator port are connected to each other, and
a relief valve is provided to the bridge oil passage.
